(19) United States
(12) Patent Application Publication
(10) Pub. No.: US 2015/0042798 A1
(43) Pub. Date: Feb. 12, 2015

(54) IN-VEHICLE CAMERA

(71) Applicant: Honda elesys Co., Ltd., Yokohama-shi (JP)

(72) Inventor: Naoya Takeda, Yokohama-shi (JP)

(73) Assignee: Honda elesys Co., Ltd., Yokohama-shi (JP)

(21) Appl. No.: 13/962,611

(22) Filed: Aug. 8, 2013

(51) Int. Cl. H04N 5/225; H04N 7/18

(52) U.S. Cl. CPC H04N 5/2252; H04N 7/18
USPC 348/148

(57) ABSTRACT

An in-vehicle camera that is provided with a substrate, a camera body, a housing including the substrate and the camera body. The substrate is provided with the opening, and the camera body is attached to the position of the opening of the substrate. Furthermore, the camera body is included in the housing, with a part thereof inserted into the opening.

### BACKGROUND OF THE INVENTION

1. Field of the Invention

The invention relates to an in-vehicle camera, and more particularly, an in-vehicle camera mounted on a windshield to capture images of objects present in the frontward of a vehicle.

2. Description of the Related Art

An in-vehicle camera has been used for extracting images of on-road lane markings, an immediately preceding vehicle, an opposite vehicle, persons, traffic signs, road markings, and the like by processing images captured by the camera installed in the vehicle. Such an in-vehicle camera is also applied for an in-vehicle system for assisting safety driving of a vehicle, a monitoring system for detecting abnormalities and an intrusion of a suspicious person, and other systems.

As a typical example of these image-processing in-vehicle cameras to extract various pieces of information from an image, there is known the type which is mounted on a vehicle's windshield to monitor the forward of the vehicle. The requirements of these cameras include a narrower installation space. In recent years, a vehicle has come to be equipped with various sensors such as a rain sensor, an illuminance sensor, a millimeter-wave or a laser-radar sensor. This requires for an installation space of devices in a vehicle to be as small to install the devices as compactly as possible. Especially inside the vehicle, to avoid obstructing driving, it is required to install each device at a position or in a size that does not obstruct driver's vision nor give a feeling of oppression to the driver.

For the above requirements, an in-vehicle camera has been developed which is capable of being reduced in the attachment space on the windshield of a vehicle and includes a substrate, an imaging element having an optical axis in a direction perpendicular to the surface of the substrate, a lens disposed on the optical axis, and a mirror changing a direction of the optical axis to the frontward of the vehicle as shown in, for example, Patent Document 1 below. Further, as a product relating to the in-vehicle camera, a vehicle-oriented accessory system is disclosed which contains an in-vehicle camera therein and includes a module being attached on the windshield for use as shown in, for example, Patent Document 2 below.

### RELATED DOCUMENTS

### Patent Documents

1. US patent document 2009-0046149 A1 (JP patent document 2009-40270 A)
2. US patent document 8405726-B2

A conventional in-vehicle camera, however, has a problem mentioned below.

The in-vehicle camera disclosed in the patent document 1 includes an optical module (a camera body) provided with a lens and a mirror, disposed at the outer frontward of the substrate. This has caused a problem that when the in-vehicle camera is attached on the windshield of the vehicle, the in-vehicle camera becomes so large in a size in an oblique front-rear direction of a vehicle that the camera becomes an obstacle to the frontward view of a driver.

Since the optical module of the in-vehicle camera is provided with a mirror and an attachment to which the mirror is attached, there is also a problem that a structure at the position of the in-vehicle camera becomes so thick that the camera becomes an obstacle to the frontward view of the driver. Particularly, since a thick optical module is disposed at the outer frontward of the substrate, there is a problem that the optical module, when attached on the vehicle windshield, tends to come into the driver's view and to become an obstacle in the frontward view of the driver.

An invention disclosed in the other US patent document No. 2 relates to a vehicle-oriented accessory system, and it is not considered to make smaller the attachment space of the camera to a windshield. Thus, the module disclosed in the patent document No. 2 is not intended for miniaturization.

### SUMMARY OF THE INVENTION

Accordingly, an object of the invention is to provide an in-vehicle camera that is able to be made smaller in its external dimensions and thickness.

In order to solve the above mentioned problem, an in-vehicle camera according to the invention includes a substrate; a camera body; and a housing including the substrate and the camera body. The substrate is provided with an opening and the camera body is attached at the position of the opening of the substrate.

According to the above structure, since the camera body is provided in the position of the opening of the substrate, the in-vehicle camera becomes shorter and smaller in its external dimensions. Additionally, since the camera body does not have a thick structure, the in-vehicle camera becomes thinner in its structure at its position.

The in-vehicle camera according to the invention preferably includes in the housing the camera body with a portion thereof inserted into the opening.

Such a structure makes the structure of the camera body in the in-vehicle camera further thinner and results in a further thinner structure of the in-vehicle camera at its position.

The in-vehicle camera according to the invention preferably includes the housing provided with a base housing supporting the substrate, and a cover housing opposing to the base housing and supporting the camera body. The cover housing is preferably provided with a lens window part for the camera body, protruding from a surface of the cover housing. And the housing is preferably formed so that the housing becomes thinner from an end position of the lens window part toward an end portion of the housing.

According to such a structure, the in-vehicle camera becomes thinner from the end position of the lens window part toward the end portion of the in-vehicle camera. As a result, the in-vehicle camera becomes hard to come into view when the in-vehicle camera is attached to the windshield.

In the in-vehicle camera according to the invention, a processing-circuit element of the in-vehicle camera is preferably abutted to the housing through a heat-radiating member.

According to such a structure, since the heat generated by the processing-circuit element is radiated from the heat-radiating member, the in-vehicle camera is improved in heat-radiating performance.

In the in-vehicle camera according to the invention, it is preferable that the substrate is provided with the opening at a center, an element that has an installation height from the substrate larger than a predetermined reference value at one side around the center, and another element that has an installation height from the substrate smaller than the predetermined reference value at the other side around the center. The fin member is preferably provided in a space facing to the other side around the opening of the substrate, and protruding from the housing toward the inner side.

According to such a structure, the in-vehicle camera includes the fin member in the inner side of the housing, thereby the surface area of the predetermined portion of the housing becomes larger and heat generated in the inner-side of the in-vehicle camera is radiated through the fin member, which improves heat-radiating performance of the in-vehicle camera.

In the in-vehicle camera according to the invention, the substrate is preferably 70 to 80 mm long in the longitudinal direction, and 50 to 60 mm in the lateral direction; the opening of the substrate is preferably 10 to 20 mm long in the longitudinal direction, and 15 to 25 mm in the lateral direction.

According to such a structure of the in-vehicle camera, by defining the sizes of the substrate and the opening as the above, the substrate can be made suitable in size, for each element of the in-vehicle camera to become easy to be installed onto the substrate. And the part of the camera body becomes easy to be inserted into the opening.

According to the in-vehicle camera of the invention, since the external dimensions of the in-vehicle camera can be made small, the attachment space to the windshield and the thickness of the in-vehicle camera can be made small. This prevents the in-vehicle camera from obstructing the frontward view of the driver when the in-vehicle camera is attached to the windshield.

### BRIEF DESCRIPTION OF THE DRAWINGS

FIG. 1 is an exploded perspective view showing a whole structure of the in-vehicle camera according to an embodiment of the invention.

FIG. 2 is an exploded side view showing a whole structure of the in-vehicle camera according to the embodiment.

FIG. 3 is a perspective view showing an external structure of the in-vehicle camera according to the embodiment.

FIG. 4 is a schematic view showing a situation in which the in-vehicle camera according to the embodiment is attached to the vehicle windshield.

FIGS. 5A and 5B are schematic views showing another embodiment of the in-vehicle camera according to the invention. FIG. 5A is a perspective view showing a situation in which the housing is provided with a fin member and a groove; and FIG. 5B is a top view showing a position relation of a fin member.

### DETAILED DESCRIPTION OF THE PREFERRED EMBODIMENT

Hereinafter, an embodiment to implement the in-vehicle camera according to the invention is described in detail referring to the drawings. Note that sizes, position relations, or the like of members or the like showed in the drawings are sometimes magnified for clear description.

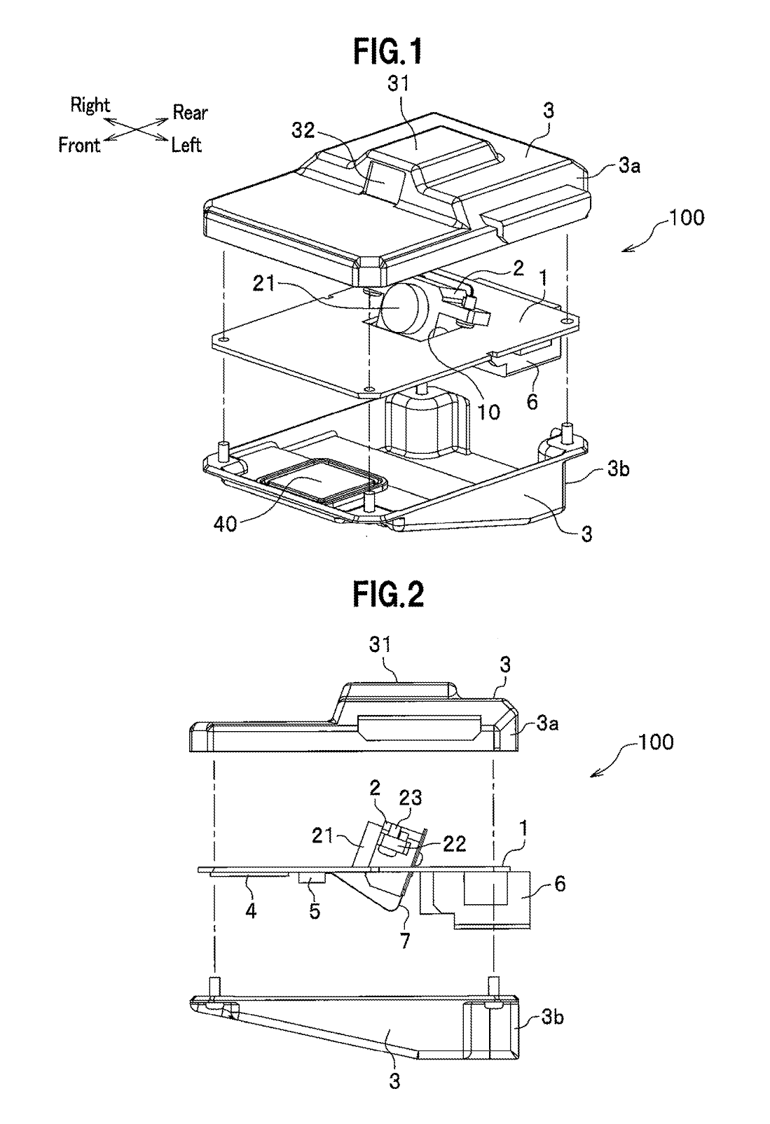

As shown in FIGS. 1 to 3, the in-vehicle camera 100 captures images while travelling. The in-vehicle camera 100 includes the substrate 1, the camera body 2, and the housing 3 including the substrate 1 and the camera body 2 therein.

Now, each member's structure is described.

The substrate 1 is a member for capturing an image with the camera body 2, to storing the captured image, and transmitting the image to another device. On the substrate 1, the camera body 2, a processing-circuit element 4, a first connector 5, a second connector 6, and the like are mounted. A reverse face of the substrate 1 is provided with members (not shown) necessary for the in-vehicle camera 100, such as a power supply circuit element, a condenser, a microcomputer, and ICs. Note that the reverse face of the substrate 1 is a face of opposite side to a side on which the camera body 2 is disposed.

The substrate 1 has a rectangular shape formed by sides in a longitudinal direction of the substrate 1 which is a front-rear direction in the in-vehicle camera 100 and sides in a lateral direction perpendicular to the longitudinal direction. Note that “the front-rear direction in the in-vehicle camera 100” is a direction along which the in-vehicle camera 100 captures an image, and means a direction along which an optical axis of the camera runs, as shown in FIG. 1. “The longitudinal direction” is a front-rear direction in FIG. 1 and a direction which becomes the oblique front-rear direction of the vehicle body when the in-vehicle camera 100 is attached to the windshield 50 (refer to FIG. 4). And, “the lateral direction” is the right-left direction in FIG. 1.

The size of the substrate 1 is not defined as a particular value, but for example, it is preferable that the length in the longitudinal direction of the substrate 1 is 70 to 80 mm, and that the length in the lateral direction of the substrate 1 is 50 to 60 mm. If the substrate 1 has this size, each member provided to the substrate is easy to attach, and the in-vehicle camera 100 does not become larger than necessary.

The thickness of the substrate 1 is not also defined as a particular value, but for example, preferably 1.0 to 1.6 mm. When the thickness of the substrate 1 is in this range, the substrate 1 is kept in the strength to be free from problems for practical use, without becoming thicker than necessary.

The substrate 1 is provided with an opening 10. The opening 10 is used to insert a portion of the camera body 2 therein as described later. And, the opening 10 is used to pass through a flexible print circuit board (FPC) 7 which electrically connects the camera body 2 with the first connector 5, as described later.

The opening 10 is a hole perforated in the substrate 1 at a predetermined position of the substrate 1 with a predetermined size. Here is provided the opening 10 at a little backward from the center in the longitudinal direction of the substrate 1 (the opposite side to the direction for capturing an image), and at the central area in the lateral direction of the substrate 1. The size of the opening 10 is not defined as a particular value, and may be properly adjusted according to the sizes of the substrate 1 or the camera body 2. One example is that the longitudinal direction may be made 10 to 20 mm and the lateral direction may be made 15 to 25 mm. When the opening 10 has this size, each member is easy to install onto the substrate, and a portion of the camera body is easy to insert into the opening 10. Each element installed on the substrate 1 is described later.

The camera body 2 is a device that captures an image from visual information of an object. The camera body 2 is provided with a lens 21 in a lens-storage part with a cylindrical form, and an image sensor (not shown) is included at a focal point on an optical axis of the lens 21.

The lens 21 is disposed protruding at the frontward position of the camera body 2, and plural types of lenses are used together so that the depth of field is configured similar to a typical digital camera. The image sensor is an element that captures outside visual information as an image. For an element used to capture an image, for example, CMOS is used.

The camera body 2 is installed at the position of the opening 10. Here, the camera body 2 is fixed to the housing 3 so that a portion thereof is inserted into the opening 10 of the substrate 1. That is, the camera body 2 is attached to the substrate 1 with a situation in which the portion of the camera body 2 is buried under the opening 10 while the camera body 2 is placed in the cover housing 3a. Note that here is illustrated the camera body 2 in the situation in which the camera body 2 is separated from the cover housing 3a for convenience of illustration.

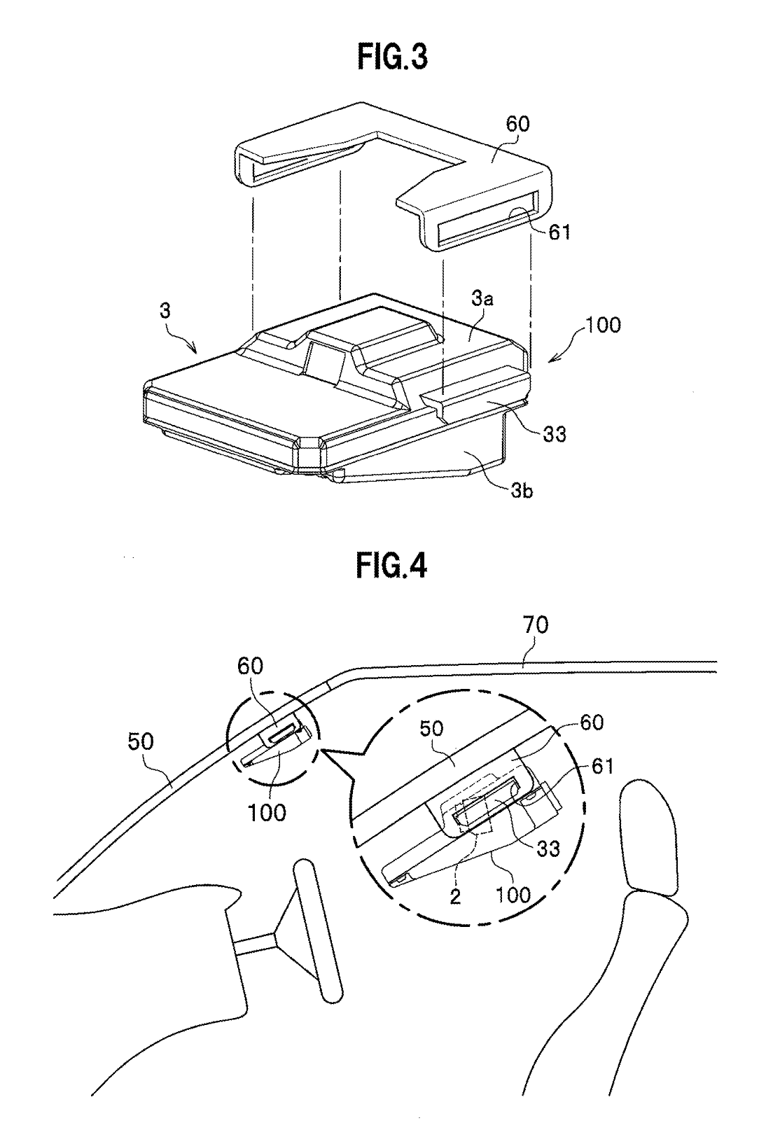

Specifically, the camera body 2 is provided with fixing protrusions 22 at the backward thereof and fixing members 23 that is each a screw inserted into a hole of the fixing protrusion 22. And, the camera body 2 is fixed to the inner side of the cover housing 3a with the fixing member 23. The camera body 2 is fixed to the cover housing 3a with a predetermined angle so that the direction of the lens 21 faces toward a lens window opening 32 of the lens window part of the cover housing 3a. Then, when the substrate 1 is included in the housing 3 (refer to FIG. 3) by putting together the cover housing 3a and the base housing 3b, the bottom portion of the camera body 2 is inserted into the opening 10.

The depth of the bottom portion of the camera body 2 which is inserted into the opening 10 may not be defined as a particular value but adjusted properly according to the size of the camera body 2 or the housing 3. One example is 5 to 15 mm.

Thus, the in-vehicle camera 100 can have the place of the camera body 2 further thinner, by arrangement such that the camera body 2 is partly buried under the opening 10 of the substrate 1. This enables for the in-vehicle camera 100 to be further thinner.

Additionally, since the in-vehicle camera 100 becomes easy to regulate an insertion rate at which the camera body 2 is inserted into the opening 10 by providing the camera body 2 at the position of the opening 10, the camera body 2 becomes easy to be regulated in the thickness in the in-vehicle camera 100. Furthermore, since providing the camera body 2 with the opening 10 prevents the bottom of the camera body 2 from getting contact with the substrate 1 regardless the angle of the camera body 2, the camera body 2 becomes easy to be installed onto the cover housing 3a at a predetermined angle.

And, being installed at the position of the opening 10 of the substrate 1, the camera body 2 comes into a situation in which the camera body 2 is installed at the position that is a little backward from the center in the longitudinal direction of the substrate 1 (the opposite direction to the image capturing direction) and the center in the lateral direction. Additionally, being installed at the position of the opening 10 of the substrate 1, the camera body 2 comes into the situation in which it is installed within a plane surface of the substrate 1. “Being installed within a plane surface of the substrate” is being installed within a projection area of the substrate 1. It means that the camera body 2 is disposed so that a part of the camera body 2 does not extend beyond the edge of the substrate 1.

The housing 3 is a member that includes the substrate 1 and the camera body 2. Additionally, the housing 3 also includes the processing-circuit element 4, the first connector 5, the second connector 6, FPC 7, and other members, which are all connected to the substrate 1.

Here, the housing 3 is provided with the base housing 3b supporting the substrate 1, and the cover housing 3a which is provided opposing the base housing 3b and supports the camera body 2. For material of the housing 3, aluminum or alloy thereof is considered, and sheet metal made of them can be used. Or, for material of the housing 3, resin can be also used.

The cover housing 3a is provided with the lens window part 31 for the camera body 2 protruding from a surface of the cover housing. That is, when the substrate 1 is included in the housing 3, the lens window part 31 is provided at a portion in the cover housing 3a where the camera body 2 is placed, so that the camera body 2 is contained within the housing 3.

The lens window part 31 has a form protruding from the cover housing 3a according to the form of the camera body 2. And, in the lens window part 31, the lens window opening 32 is formed with a frontward portion opened where the lens is placed so that the lens 21 of the camera body 2 can obtain information from the exterior of the vehicle. Furthermore, the cover housing 3a has a structure in which a housing thickness from the frontend position of the lens window part 31 to the frontend of the cover housing 3a is small. That is, the cover housing 3a is formed so that the housing becomes thinner from a predetermined position near the center to the frontend.

Here, “the end position of the lens window part 31” is the end most portion in the direction to the end portion of the cover housing 3a in the lens window part 31 and the portion where the bottom part of the lens window opening 32 is placed. And, “a housing thickness from the frontend position of the lens window part 31 to the frontend of the cover housing 3a is small” does not mean that the thickness is small only in the width of the lens window part 31 in the cover housing 3a, but that the thickness is small in all the width of the cover housing 3a.

The base housing 3b has a cut-out formed at backward thereof so that a predetermined portion of the second connector 6 is included in the base housing 3b when the substrate 1 is included in the base housing 3b. Note that a backward portion of the second connector 6 is exposed from the backward of the base housing 3b to the exterior.

At a position of the processing-circuit element 4, a heat-radiating member 40 is provided. Additionally, the bottom of the base housing 3b has a structure in which the bottom has a slope so that the housing becomes thinner from a predetermined position of the backend to the frontend.

Furthermore, the housing 3 is united by putting together the cover housing 3a and the base housing 3b opposing with each other (refer to FIG. 3). In this situation, since the cover housing 3a and the base housing 3b have the aforementioned shapes, the housing 3 is formed to become thinner from the frontend position of the lens window part 31 to the frontend of the housing 3.

That is, in the in-vehicle camera 100, the housing 3 is formed so that the housing 3 becomes gradually thinner from the predetermined position at the backward (rear end) of the in-vehicle camera 100 to the frontend position of the lens window part 31, and is formed so that the housing 3 becomes gradually thinner from the frontend position of the lens window part 31 to the frontward (front end) of the in-vehicle camera 100. Note that “the frontward of the in-vehicle camera 100” is a direction of the “Front” indicated in FIG. 1 and that “the backward of the in-vehicle camera 100” is a direction of the “Rear” indicated in FIG. 1.

Next, described is each element and the like mounted on the substrate 1.

The processing-circuit element 4 is an element that processes an image captured by the image sensor, and mounted on a predetermined position of a reverse face of the substrate 1. The processing-circuit element 4 performs extraction of various characteristic objects such as a vehicle, a pedestrian, a lane marking, and the like from visual information formed as an image on the image sensor.

Here, the processing-circuit element 4 is abutted on the base housing 3b thorough the heat-radiating member 40. For the heat-radiating member 40, a heat-radiating plate/sheet or a heat-radiating gel can be used. For material of a heat-radiating plate/sheet, silicon-based material and the like may be used. For material of a heat-radiating gel, silicon-based material and the like may be also used. The processing-circuit element 4 generates heat when the in-vehicle camera 100 is powered on. Heat-radiating performance of the in-vehicle camera 100 can be improved by abutting the processing-circuit element 4 on the base housing 3b in contact with the heat-radiating member 40.

The first connector 5 is a member to which the FPC7 is connected, and mounted on a predetermined position of the reverse face of the substrate 1. The first connector 5 transmits image data from the FPC7 to the processing-circuit element 4.

The second connector 6 (power connector) is a member that is used for power supply and communications, and mounted on a rear portion of the reverse face of the substrate 1. The second connector 6 supplies power from the vehicle to the in-vehicle camera 100, and outputs to the exterior a calculation result calculated by the processing-circuit element 4.

The FPC7 is a member that electrically connects the camera body 2 with the first connector 5 mounted on a predetermined position of the reverse face in the substrate 1. The FPC7 is disposed at the backward of the camera body 2 and connected with the backward portion of the camera body 2 to be connected with the image sensor in the camera body 2, and also connected with the first connector 5 passing through the opening 10.

With the opening 10 on the substrate 1, the FPC7 can be shortened and the connection of the camera body 2 with the first connector 5 can be simplified.

Next, described is an attachment state of the in-vehicle camera 100.

As shown in FIG. 4, the in-vehicle camera 100 is attached on the inner side of the windshield 50 of the vehicle so that the cover housing 3a faces to the side of the windshield 50 and the frontward of the in-vehicle camera 100 is directed to the slantingly downward (slantingly frontward). That is, the in-vehicle camera 100 is attached so that the camera body 2 is placed at the side of the windshield 50 and that the backward of the in-vehicle camera 100 is directed to the ceiling 70 at the same time.

The in-vehicle camera 100 is attached through an attaching member 60. The attaching member 60 is provided beforehand at a predetermined position of a windshield 50, for example, near a rearview mirror, fixed with double-sided tape, adhesive, or the like. The attaching member 60 has a shape such that the in-vehicle camera 100 can be fitted therein and fixed thereto by engaging an engaging part 61 with an attaching protrusion 33 of the cover housing 3a. Thus, by fitting the in-vehicle camera 100 into the attaching member 60 and fixing the in-vehicle camera 100 with the engaging part 61 to connect the in-vehicle camera 100 to the attaching member 60, the in-vehicle camera 100 can be attached on the predetermined position of the windshield 50.

The lens 21 of the in-vehicle camera 100 is adjusted beforehand to be directed to the travelling direction of the vehicle when the in-vehicle camera 100 is attached to the windshield 50. An attachment position in a windshield 50 of the in-vehicle camera 100, and an angle of the lens 21 can be adjusted properly according to an object or the like to be imaged.

At the same time, since the in-vehicle camera 100 according to the embodiment of the invention is small in its external dimensions, its attachment space to the windshield 50 can be small. Also, the in-vehicle camera 100 becomes smaller in thickness thereof. Therefore, the in-vehicle camera 100 does not become an obstacle to the frontward view of the driver when attached to the windshield 50. Furthermore, the in-vehicle camera 100 becomes thinner in the direction from the predetermined position at the backward to the frontward of the in-vehicle camera 100. Therefore, the in-vehicle camera 100 does not become an obstacle to the frontward view of the driver and is further hard to come into the view, which reduces a feeling of discomfort given by the in-vehicle camera 100.

Next, described is the operation of the in-vehicle camera 100.

First, an electric current is supplied to the in-vehicle camera 100 via the second connector 6 from a power supply of the vehicle. The electric current is converted to a necessary voltage in a power supply circuit element, and then supplied to each microcomputer, each IC, and the like on the substrate 1.

Next, the lens 21 of the camera body 2 acquires external visual information, and forms an image of the visual information on the image sensor in the camera body 2. The visual information formed as the image on the image sensor is transmitted to the processing-circuit element 4 via the FPC 7 and the first connector 5. Then the processing-circuit element 4 performs extraction of various characteristic objects such as a vehicle, a pedestrian, a lane marking. Finally, the final calculation result calculated in the processing-circuit element 4 is outputted to the exterior via the second connector 6.

The above describes the invention in detail by showing the embodiments and implementation examples of the invention, but the subject matter of the invention should not be limited into the above-mentioned descriptions, and the scope of the patent-right of the invention should be understood widely based on the description of the claims. Note that the content of the invention can be, of course, widely revised and changed based on the above mentioned description.

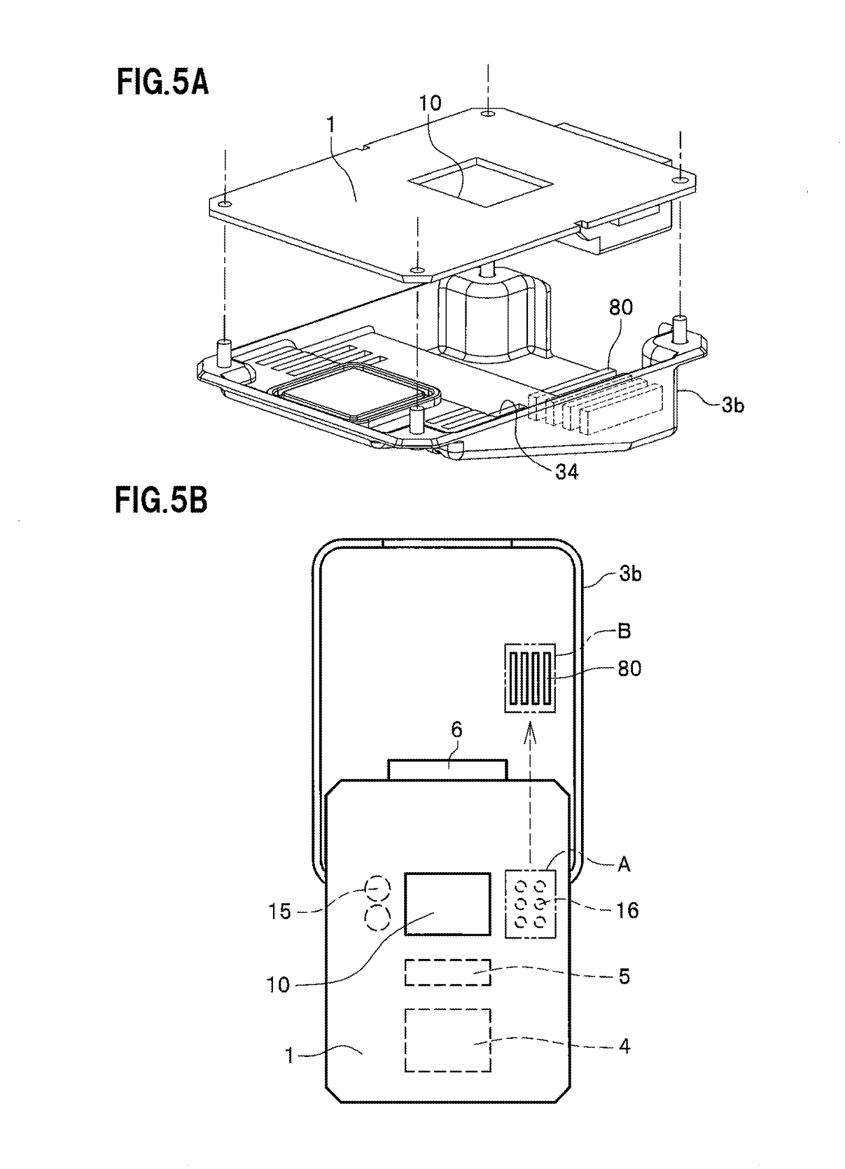

For example, as shown in FIGS. 5A and 5B, the in-vehicle camera 100 may be configured to include a fin member 80 for heat radiation on an inner surface of the base housing 3b. Here, the substrate 1 is provided with the opening 10 in a central area, an element (a condenser 15) that has an installation height from the substrate 1 larger than a predetermined reference value on one side around the opening 10, and another element (a device member 16) that has an installation height from the substrate 1 smaller than the predetermined reference value on the other side around the opening 10. Note that the “predetermined reference value” is an installation height from the substrate 1 set according to a shape, a size, and the like of the in-vehicle camera 100, and is a value arbitrarily determined so that the substrate 1 provided with each element and the like can be included in the housing. And in the vacant space facing the other side around the opening 10, provided is the fin member 80 protruding forward the inner side from the housing (the base housing 3b).

Specifically, the opening 10 is disposed in the central area in the lateral direction on the substrate 1, and the condenser 15 with a predetermined length is disposed on the right side around the opening 10 when facing to the frontward of the in-vehicle camera 100 (the left side in FIG. 5B). On the left side around the opening 10 when facing to the frontward of the in-vehicle camera 100 (the right side in FIG. 5B), the element member 16 with a predetermined length is also disposed.

Additionally, the fin member 80 is provided at the part (area B) of the base housing 3b facing to, when the substrate 1 is included within the housing 3, the part (area A) where the element member 16 is disposed.

The fin member 80 is made of plurality of planar materials each extending in the longitudinal direction on the base housing 3b. Here are aligned four planar materials parallel in the lateral direction on the base housing 3b. The fin member 80 has a predetermined height from the inner bottom of the base housing 3b and protrudes forward the substrate 1. The form, height, or the like of the fin member 80 may be properly adjusted according to the form, size, and the like of the in-vehicle camera 100.

Thus, including the fin members 80 can increase the area of the inner surface (the portion of the area B) of the base housing 3b and make it easy to radiate the heat generated at the element member 16.

Though the above mentioned embodiment is structured such that the camera body 2 is installed in the housing 3 by inserting the part of the camera body 2 into the opening 10, another structure may be allowable such that the part of the camera body 2 is not inserted into the opening 10, only if the camera body 2 is disposed at the position of the opening 10. Even in this case, the camera body 2 also makes the thickness of the in-vehicle camera 100 smaller because the camera body 2 includes none of a mirror and an attachment. Furthermore, since this structure enables the FPC7 to pass through the opening 10 just under the camera body 2 to connect with the first connector 5, the FPC7 can be shorter and easy to connect with the first connector 5.

In another embodiment, the in-vehicle camera 100 may be structured to be provided with a groove (or a thorough hole) 34 for heat radiation in the bottom surface of the base housing 3b. The groove 34 may be formed, for example, as plural grooves lined up in the lateral direction on the base housing 3b, each groove extending by a predetermined width in the longitudinal direction on the base housing 3b. Including the grooves 34 in the bottom face of the base housing 3b further improves the heat-radiating performance. Such grooves may be also provided at the front end surface or the rear end surface of the in-vehicle camera 100. That is, at the front end surface or the rear end surface of the in-vehicle camera 100, plural of the grooves with the shape extending along the bottom-to-up direction by a predetermined width may be formed in the lateral direction.

In yet another embodiment, the in-vehicle camera 100 may be structured to include the cover housing 3a having a slope becoming thinner in the direction from the rear end to the front end. This structure can form the housing 3 to become gradually thinner in the direction from the predetermined position at the backward (rear end) to the frontward (front end) except the part where the camera body 2 is disposed in the in-vehicle camera 100.

The arrangement, size, or the like of the opening 10 of the substrate 1, the camera body 2, the processing-circuit element 4, or the like are described as one of the examples in the above mentioned embodiment and may be appropriately modified according to the configuration of the in-vehicle camera 100.

1. An in-vehicle camera comprising:
a substrate provided with an opening;
a camera body provided at a position of the opening of the substrate; and
a housing including the substrate and the camera body.

2. The in-vehicle camera according to claim 1, wherein
the camera body is provided in the housing, with a part of the camera body being inserted into the opening.

3. The in-vehicle camera according to claim 1, wherein
the housing comprising:
a base housing supporting the substrate; and
a cover housing opposing to the base housing and supporting the camera body, wherein
the cover housing is provided with a lens window part for the camera body, the lens window part protruding from a surface of the cover housing; and
the housing is formed to become smaller in thickness thereof in the direction from an front end position of the lens window part toward an front end of the housing.

4. The in-vehicle camera according to claim 1, wherein
a processing-circuit element of the in-vehicle camera is abutted to the housing via a heat-radiating member.

5. The in-vehicle camera according to claim 1, wherein
the substrate is provided with:
the opening being arranged in a central area;
a first element arranged on one side around the opening, the first element being larger than a predetermined reference value in installation height thereof from the substrate; and
a second element arranged on the other side around the opening, the second element being smaller than the predetermined reference value in installation height thereof from the substrate, and wherein
a fin member is provided in a space facing the other side around the opening, and protruding from the housing toward the inner side.

6. The in-vehicle camera according to claim 1, wherein
a length in a longitudinal direction of the substrate is 70 to 80 mm,
a length in a lateral direction of the substrate is 50 to 60 mm,
a length in a longitudinal direction of the opening is 10 to 20 mm,
a length in a lateral direction of the opening is 15 to 25 mm.

7. The in-vehicle camera according to claim 2, wherein
the housing comprising:
a base housing supporting the substrate; and
a cover housing opposing to the base housing and supporting the camera body, wherein
the cover housing is provided with a lens window part for the camera body, the lens window part protruding from a surface of the cover housing; and
the housing is formed to become smaller in thickness thereof in the direction from an front end position of the lens window part toward an front end of the housing.

8. The in-vehicle camera according to claim 2, wherein
a processing-circuit element of the in-vehicle camera is abutted to the housing via a heat-radiating member.

9. The in-vehicle camera according to claim 3, wherein
a processing-circuit element of the in-vehicle camera is abutted to the housing via a heat-radiating member.

10. The in-vehicle camera according to claim 7, wherein
a processing-circuit element of the in-vehicle camera is abutted to the housing via a heat-radiating member.

11. The in-vehicle camera according to claim 2, wherein
the substrate is provided with:
the opening being arranged in a central area;
a first element arranged on one side around the opening, the first element being larger than a predetermined reference value in installation height thereof from the substrate; and
a second element arranged on the other side around the opening, the second element being smaller than the predetermined reference value in installation height thereof from the substrate, and wherein
a fin member is provided in a space facing the other side around the opening, and protruding from the housing toward the inner side.

12. The in-vehicle camera according to claim 3, wherein
the substrate is provided with:
the opening being arranged in a central area;
a first element arranged on one side around the opening, the first element being larger than a predetermined reference value in installation height thereof from the substrate; and
a second element arranged on the other side around the opening, the second element being smaller than the predetermined reference value in installation height thereof from the substrate, and wherein
a fin member is provided in a space facing the other side around the opening, and protruding from the housing toward the inner side.

13. The in-vehicle camera according to claim 4, wherein
the substrate is provided with:
the opening being arranged in a central area;
a first element arranged on one side around the opening, the first element being larger than a predetermined reference value in installation height thereof from the substrate; and
a second element arranged on the other side around the opening, the second element being smaller than the predetermined reference value in installation height thereof from the substrate, and wherein
a fin member is provided in a space facing the other side around the opening, and protruding from the housing toward the inner side.

14. The in-vehicle camera according to claim 7, wherein
the substrate is provided with:
the opening being arranged in a central area;
a first element arranged on one side around the opening, the first element being larger than a predetermined reference value in installation height thereof from the substrate; and
a second element arranged on the other side around the opening, the second element being smaller than the predetermined reference value in installation height thereof from the substrate, and wherein
a fin member is provided in a space facing the other side around the opening, and protruding from the housing toward the inner side.

15. The in-vehicle camera according to claim 8, wherein
the substrate is provided with:
the opening being arranged in a central area;
a first element arranged on one side around the opening, the first element being larger than a predetermined reference value in installation height thereof from the substrate; and
a second element arranged on the other side around the opening, the second element being smaller than the predetermined reference value in installation height thereof from the substrate, and wherein
a fin member is provided in a space facing the other side around the opening, and protruding from the housing toward the inner side.

16. The in-vehicle camera according to claim 9, wherein
the substrate is provided with:
the opening being arranged in a central area;
a first element arranged on one side around the opening, the first element being larger than a predetermined reference value in installation height thereof from the substrate; and
a second element arranged on the other side around the opening, the second element being smaller than the predetermined reference value in installation height thereof from the substrate, and wherein
a fin member is provided in a space facing the other side around the opening, and protruding from the housing toward the inner side.

17. The in-vehicle camera according to claim 10, wherein
the substrate is provided with:
the opening being arranged in a central area;
a first element arranged on one side around the opening, the first element being larger than a predetermined reference value in installation height thereof from the substrate; and
a second element arranged on the other side around the opening, the second element being smaller than the predetermined reference value in installation height thereof from the substrate, and wherein
a fin member is provided in a space facing the other side around the opening, and protruding from the housing toward the inner side.

18. The in-vehicle camera according to claim 2, wherein
a length in a longitudinal direction of the substrate is 70 to 80 mm,
a length in a lateral direction of the substrate is 50 to 60 mm,
a length in a longitudinal direction of the opening is 10 to 20 mm,
a length in a lateral direction of the opening is 15 to 25 mm.

19. The in-vehicle camera according to claim 3, wherein
a length in a longitudinal direction of the substrate is 70 to 80 mm,
a length in a lateral direction of the substrate is 50 to 60 mm,
a length in a longitudinal direction of the opening is 10 to 20 mm,
a length in a lateral direction of the opening is 15 to 25 mm.

20. The in-vehicle camera according to claim 7, wherein
a length in a longitudinal direction of the substrate is 70 to 80 mm,
a length in a lateral direction of the substrate is 50 to 60 mm,
a length in a longitudinal direction of the opening is 10 to 20 mm,
a length in a lateral direction of the opening is 15 to 25 mm.
